(19) United States
(12) Patent Application Publication
(10) Pub. No.: US 2021/0162733 A1
(43) Pub. Date: Jun. 3, 2021

(54) METHOD FOR MANUFACTURING BEVERAGE USE CAN, BEVERAGE USE CAN, AND BEVERAGE CAN

(71) Applicant: SHOWA ALUMINUM CAN CORPORATION, Tokyo (JP)

(72) Inventors: Shinichi OJIMA, Shinagawa-ku, Tokyo (JP); Kazunori IKEDA, Shinagawa-ku, Tokyo (JP); Kazuhisa MASUDA, Shinagawa-ku, Tokyo (JP); Hitomi MATSUSHIMA, Shinagawa-ku, Tokyo (JP)

(73) Assignee: SHOWA ALUMINUM CAN CORPORATION, Tokyo (JP)

(21) Appl. No.: 16/772,798

(22) PCT Filed: Dec. 17, 2018
(86) PCT No.: PCT/JP2018/046330

§ 371 Date: Jun. 14, 2020

(30) Foreign Application Priority Data
Jan. 9, 2018 (JP) 2018-001181

(51) Int. Cl. B41F 17/22; B41M 1/02; B41M 1/28; B41J 2/21; B41J 3/54; B65D 25/34

(52) U.S. Cl. CPC B41F 17/22; B41M 1/02; B41M 1/28; B65D 2203/12; B41J 3/546; B65D 25/34; B41J 2/2103

(57) ABSTRACT

A beverage use can includes a cylindrical can main body. The can main body includes a round opening at its upper portion. The can main body further includes a bottom at its lower portion. The can main body further includes an outer circumferential surface. Inkjet printing is performed over the entire outer circumferential surface of the can main body to form inkjet-printed images thereon. Then, plate printing is performed on these inkjet-printed images to form thereon images including characters. This improves quality of images formed on an outer circumferential surface of a beverage use can.

### TECHNICAL FIELD

The present invention relates to a method for manufacturing a beverage use can, a beverage use can, and a beverage can.

### BACKGROUND ART

Patent Document 1 discloses forming images by inkjet printing on an outer surface of a seamless can.

### CITATION LIST

### Patent Literature

Patent Document 1: Japanese Patent Application Laid-Open Publication No. 2012-232771

### SUMMARY OF INVENTION

### Technical Problem

Inkjet printing allows photo or similar images to be vividly printed on an outer circumferential surface of a beverage use can, as compared to the use of plate printing. Meanwhile, inkjet printing may produce some unclear printed images, such as outlines of character images becoming blurred.

An object of the present invention is to improve quality of images formed on an outer circumferential surface of a beverage use can.

### Solution to Problem

A first aspect of the present invention relates to a method for manufacturing a beverage use can, the method including: forming an image on an outer circumferential surface of a can body by inkjet printing; and forming another image including a character image on the outer circumferential surface of the can body by plate printing, the another image being formed in an area that is smaller than another area in which the image is formed by inkjet printing.

The image formed by the inkjet printing may be formed over an entirety of the outer circumferential surface of the can body, and the another image including the character image formed by the plate printing may be formed on a portion of the outer circumferential surface of the can body.

Image formation by the inkjet printing and image formation by the plate printing may be performed such that the image formed by the inkjet printing and the another image formed by the plate printing do not overlap each other.

Image formation by the plate printing may be performed after image formation by the inkjet printing.

The inkjet printing may include forming, on the outer circumferential surface of the can body, the image including a photo image.

The plate printing may include forming, on the outer circumferential surface of the can body, the another image including the character image that represents at least one of information on a manufacturer and information on contents in the can body.

A second aspect of the present invention relates to a method for manufacturing a beverage use can, the method including: forming an image on an outer circumferential surface of a can body by inkjet printing; and forming another image including a trademark and/or a code image on the outer circumferential surface of the can body by plate printing, the another image being formed in an area that is smaller than another area in which the image is formed by inkjet printing.

A third aspect of the present invention relates to a method for manufacturing a beverage use can, the method including: forming an image on an outer circumferential surface of a can body by inkjet printing; and forming another image in an area on the outer circumferential surface of the can body by plate printing, the area extending in an axial direction of the can body, the area being smaller than another area in which the image is formed by inkjet printing.

The area extending in the axial direction may include a plurality of the areas extending in the axial direction, the plurality of the areas being located at mutually different positions in a circumferential direction of the can body, and a sum of the plurality of the areas extending in the axial direction may be smaller than the another area in which the image is formed by inkjet printing.

Image formation by the plate printing may be performed after image formation by the inkjet printing.

The image formed by the inkjet printing may be formed over an entirety of the outer circumferential surface of the can body, and then the another image formed by the plate printing may be formed on the image formed by the inkjet printing.

A fourth aspect of the present invention relates to a method for manufacturing a beverage use can, the method including: forming a multi-level image on an outer circumferential surface of a can body by inkjet printing, the multi-level image being included in images to be formed on the outer circumferential surface; and forming a binary image by plate printing in an area that is smaller than another area in which the multi-level image is formed by inkjet printing.

A fifth aspect of the present invention relates to a beverage use can including: a can main body of a cylindrical shape; an image part formed on an outer circumferential surface of the can main body, the image part being formed by inkjet head printing; another image part formed on the outer circumferential surface of the can main body, the another image part being smaller in area than the image part, the another image part being formed by plate printing, the another image part including at least one of a character image, a trademark, and a code image.

A sixth aspect of the present invention relates to a beverage use can including: a can main body of a cylindrical shape; an overall image formed on an outer circumferential surface of the can main body such that the overall image extends in a circumferential direction of the can main body, the overall image being formed by inkjet head printing; and a partial image formed on a portion of the outer circumferential surface of the can main body, the partial image including at least one of a character image, a trademark, and a code image, the partial image being formed by plate printing.

A seventh aspect of the present invention relates to a beverage can including: the beverage use can according to the above fifth or sixth aspect; and contents in the beverage use can.

### Advantageous Effects of Invention

The present invention allows to improve quality of images formed on an outer circumferential surface of a beverage use can.

### BRIEF DESCRIPTION OF DRAWINGS

FIG. 1 is a perspective view of a beverage use can.

FIG. 2 is a developed view of printed images formed on an outer circumferential surface of a can body.

FIG. 3 shows printed images formed by inkjet printing among the printed images.

FIG. 4 shows printed images formed by plate printing among the printed images.

FIG. 5 is a developed view of other exemplary printed images formed on the outer circumferential surface of the beverage use can.

FIG. 6 shows printed images formed by inkjet printing among the printed images.

FIG. 7 shows printed images formed by plate printing among the printed images.

FIG. 8 is a side view of a printing apparatus.

### DESCRIPTION OF EMBODIMENTS

An embodiment of the present invention will be described below with reference to the drawings.

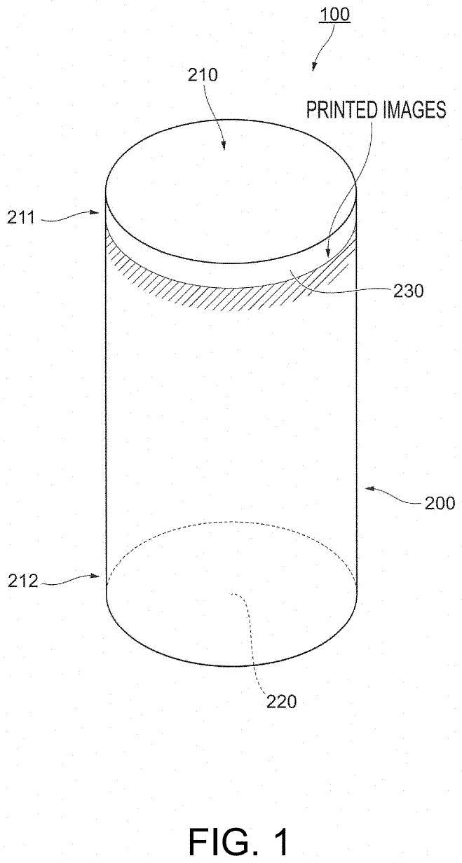

FIG. 1 is a perspective view of a beverage use can 100 according to the present embodiment.

The beverage use can 100 of the present embodiment includes a cylindrical can main body (can body) 200. The can main body 200 includes a round opening 210 at its upper portion. The can main body 200 further includes a bottom 220 at its lower portion. The can main body 200 further includes an outer circumferential surface 230.

Plate printing and inkjet printing are performed on the outer circumferential surface 230, whereby printed images are formed the outer circumferential surface 230.

In the present embodiment, a beverage as the contents of the beverage use can 100 is filled into the can main body 200 through the opening 210 at its upper portion. Then, the opening 210 is closed by a can lid (not shown). This completes a beverage can filled with the beverage.

The beverage use can 100 refers to an empty can before being filled with the beverage, and the beverage can refers to a can after being filled with the beverage as the contents thereof.

The can main body 200 is made of a metal material. Specifically, the can main body 200 is made of, for example, aluminum or aluminum alloy. Alternatively, the can main body 200 is made of, for example, iron alloy such as tin-free steel. The can main body 200 is formed by, for example, drawing and ironing (DI) of a flat plate material or stretching and drawing of the flat plate material.

Examples of the beverage filled into the can main body 200 include alcoholic beverages such as beer and non-alcoholic beverages such as soft drinks.

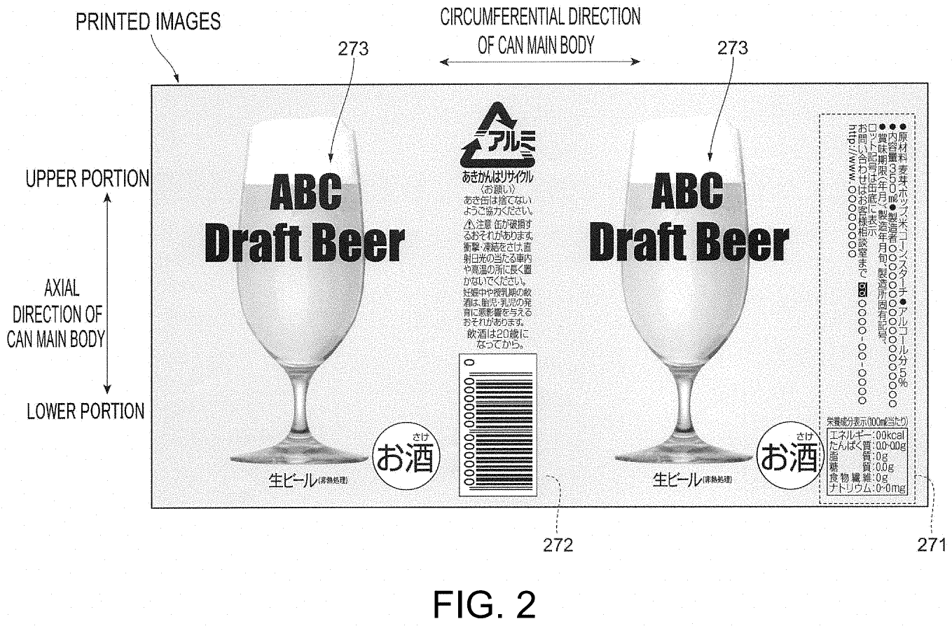

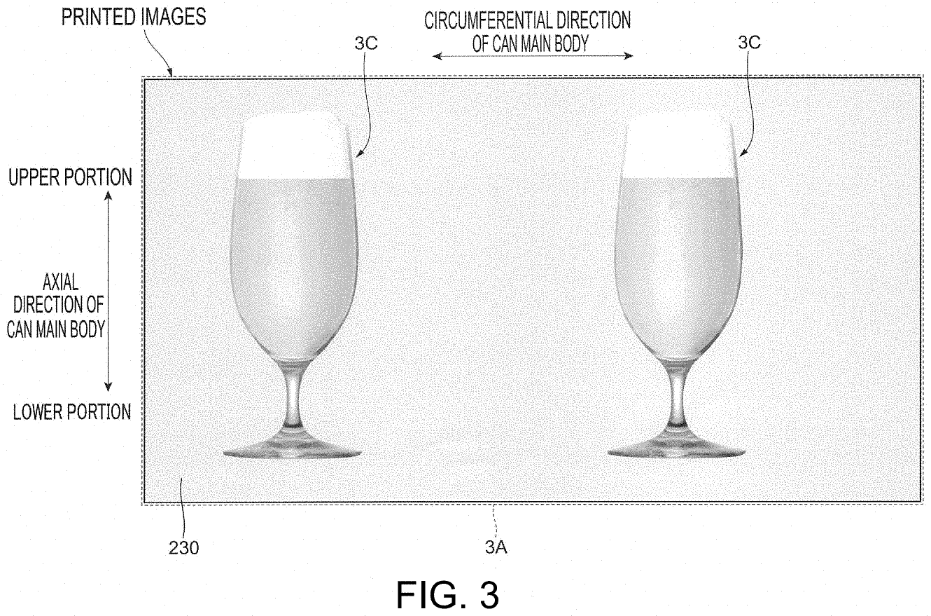

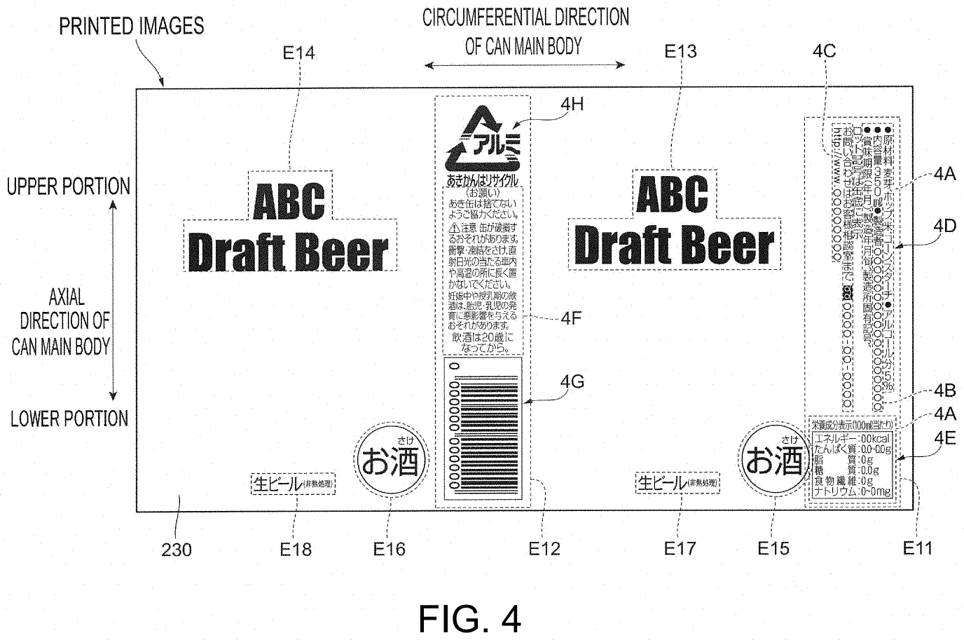

FIG. 2 is a developed view of printed images formed on the outer circumferential surface 230 of the can main body 200. FIG. 3 shows printed images formed by inkjet printing among the printed images shown in FIG. 2. FIG. 4 shows printed images formed by plate printing among the printed images shown in FIG. 2.

The printed images of the present embodiment (the printed images shown in FIG. 2) are composed of a superposition of those shown in FIG. 3 and those shown in FIG. 4.

As shown in FIG. 3, in the present embodiment, images formed by inkjet printing (hereinafter each referred to as an “inkjet-printed image”) are formed on the outer circumferential surface 230 of the can main body 200 over the entirety of the outer circumferential surface 230.

In other words, the inkjet-printed image is an example of the overall image and formed almost over the entire outer circumferential surface 230 of the can main body 200. Additionally, the inkjet-printed image is formed in a belt-like shape so as to extend in the circumferential direction of the can main body 200.

In the present embodiment, inkjet printing is performed over the entirety of the outer circumferential surface 230 of the can main body 200 to form the inkjet-printed images (images shown in FIG. 3) thereon.

In the present embodiment, plate printing is then performed on these inkjet-printed images to form images thereon by plate printing (the images shown in FIG. 4; hereinafter each referred to as a “plate-printed image”).

Here, the inkjet-printed images are formed first, followed by the plate-printed images. However, the order of image formation is not limited to this; the plate-printed images may be formed first, followed by the inkjet-printed images.

As shown in FIG. 3, in the present embodiment, photo images 3C are formed as part of the inkjet-printed images.

The photo images 3C are images formed based on photo data. It should be noted that the photo images 3C include not only those obtained from the photo data itself but also those formed based on data that is processed from the photo data. Processing the photo data includes adding an additional image(s) to the photo data.

In other words, in the present embodiment, multi-level images among the images to be formed on the outer circumferential surface 230 of the can main body 200 are formed by inkjet printing.

The multi-level images include color and gray-scale images. Forming these multi-level images by inkjet printing can make them more vivid than when they are formed by plate printing.

Meanwhile, in the present embodiment, binary images including character images (described later) and single-colored code images (described later) are formed by plate printing, among the images formed on the outer circumferential surface 230 of the can main body 200.

Referring to FIG. 4, a description will be given of images formed by plate printing (plate-printed images).

As shown in FIG. 4, in the present embodiment, the plate-printed images are formed in areas that are smaller than the area where the inkjet-printed images are formed.

Specifically, in the present embodiment, the inkjet-printed images are formed over the entirety of the outer circumferential surface 230 of the can main body 200 (see FIG. 3), whereas the plate-printed images are formed on portions of the outer circumferential surface 230 of the can main body 200, as shown in FIG. 4.

More specifically, the plate-printed images are formed in first to eighth formation areas E11-E18 on the outer circumferential surface 230 of the can main body 200, instead of over the entirety of the outer circumferential surface 230. In other words, in the present embodiment, each of the plate-printed images can be regarded as a partial image that is formed on a portion of the outer circumferential surface 230 of the can main body 200.

The first formation area E11 and the second formation area E12 are rectangular (belt-like) areas extending in the axial direction of the can main body 200. The first formation area E11 and the second formation area E12 are laid out from one end 211 (see FIG. 1) to the other end 212 of the can main body 200 in the axial direction thereof. Also, the first formation area E11 and the second formation area E12 are located at mutually different positions in the circumferential direction of the can main body 200.

In the present embodiment, the sum of the areas of the first formation area E11 and the second formation area E12 is smaller than the area where the inkjet-printed images are formed (the area inside a rectangular dashed line denoted by 3A in FIG. 3).

It should be noted that the number of formation areas extending in the axial direction of the can main body 200 may be one or three or more, instead of two (the first formation area E11 and the second formation area E12) in the present embodiment.

As shown in FIG. 4, in the present embodiment, a trademark “ABC Draft Beer” is formed in each of the third formation area E13 and the fourth formation area E14 as part of the plate-printed images.

The fifth formation area E15 and the sixth formation area E16 have a round shape. A character image “alcohol” representing the kind of contents in the can main body 200 is formed in each of the fifth formation area E15 and the sixth formation area E16.

Also, a character image “draft beer (non-heat treated)” representing the kind of contents in the can main body 200 is formed in each of the seventh formation area E17 and the eighth formation area E18.

The shape of each of the first to the eighth formation areas E11-E18 is not limited to a particular shape and may be a circle, an ellipse or a polygon. Beside these, any irregular shape may also be used. Example of the polygon include triangle and square. Pentagon or more-sided polygons may also be used.

In the present embodiment, formation of the plate-printed images (formation of images by plate printing) is performed after formation of the inkjet-printed images (formation of images by inkjet printing).

This makes the plate-printed images come on the front side as compared to when the plate-printed images are formed prior to the inkjet-printed images. This makes clearer the character images and the like included in the plate-printed images.

It should be noted that formation of the plate-printed images is not necessarily performed after formation of the inkjet-printed images; the plate-printed images may be formed prior to the inkjet-printed images.

The image formation by inkjet printing refers to a printing method in which ink is ejected from inkjet heads 411 and applied onto the can main body 200.

Any known method may be used for image formation by inkjet printing. Specifically, use may be made of piezoelectric inkjet, thermal (bubble) inkjet, continuous inkjet and the like.

The image formation by plate-printing refers to a printing method using a plate. More specifically, in this method, ink is applied to a plate and then transferred from the plate onto the can main body 200 for printing on the can main body 200.

The ink may be transferred onto the can main body 200 by direct contact between the plate and the can main body 200 or via an intermediate transfer body disposed between the plate and the can main body 200.

Example of the plate printing include letterpress printing, intaglio printing, planographic printing, and stencil printing. Any of these methods may be used for the plate printing. In the present embodiment, the plate-printed images are formed by letterpress printing.

Referring to FIG. 4, a detailed description will be given of the first formation area E11 and the second formation area E12.

Character images are formed in the first formation area E11.

More specifically, a character image (character string) representing information on the contents in the beverage use can 100 (the part denoted by 4A), a character image representing a manufacturer (the part denoted by 4B), and a character image representing contact information (the part denoted by 4C) are formed.

The character image representing information on the contents include a list of raw materials of the contents as denoted by 4D and a list of nutrition facts as denoted by 4E.

A character image is also formed in the second formation area E12.

Specifically, a character image representing a notice for use (the part denoted by 4F) is formed in the second formation area E12.

A code image as denoted by 4G is also formed in the second formation area E12. The code image refers to an image of encoded numerical values and characters. The code image includes a bar code consisting of parallel bar images and other form of code images such as two-dimensional bar code.

An image about recycling as denoted by 4H is also formed in the second formation area E12.

As described above, the present embodiment exemplarily shows the case where multiple kinds of character images are formed, including one representing information on the contents, one representing the manufacturer and one representing contact information. However, not all of these character images are essential; any or some of them may be removed and also another character image representing other information may be added.

In the above description, the plate-printed images are formed on the inkjet-printed images. In other words, the inkjet-printed images and the plate-printed images overlap each other.

However, the way of printing is not limited to this; the inkjet-printed images and the plate-printed images may be formed such that they do not overlap each other.

Specifically, for example, the inkjet-printed images may not be formed on portions where the plate-printed images are to be formed (i.e., the inkjet-printed images may be formed so as to leave blank the portions where the plate-printed images are to be formed), and then the plate-printed images may be formed on these portions.

Alternatively, for example, areas where the inkjet-printed images are to be formed may be distinctively separated from areas where the plate-printed images are to be formed, and the inkjet-printed images and the plate-printed images may be formed in respective areas.

Inkjet printing allows photo or similar images to be vividly printed on the outer circumferential surface 230 of the can main body 200, as compared to the use of plate printing.

Meanwhile, inkjet printing of those images that need to be clearly outlined, such as character images and trademarks, may result in the outline of these images becoming blurred. In view of this, in the present embodiment, those images that need to be clearly outlined, such as character images and trademarks, are formed by plate printing as described above. This makes the outline of these images clear, improving the quality of images formed on the can main body 200.

In the present embodiment, comparing the formation area for the inkjet-printed images and the formation area for the plate-printed images, the latter is smaller than the former.

In other words, comparing an area of ink applied onto the can main body 200 by inkjet printing and an area of ink applied onto the can main body 200 by plate printing, the latter is smaller than the former.

In the present embodiment, this allows for easier formation of images on the can main body 200 as compared to when the formation area for the plate-printed images is larger than the formation area for the inkjet-printed images.

Forming images by plate printing requires a plate. It also requires installation of the plate and color matching. This involves a large workload and cost. In particular, use of a larger plate often involves a larger workload and cost.

In contrast, in the present embodiment, the plate-printed image formation area is smaller than the inkjet-printed image formation area, as described above. This allows to more easily and inexpensively prepare a plate for plate printing as compared to when the plate-printed image formation area is larger than the inkjet-printed image formation area. Additionally, this smaller plate-printed image formation area allows to reduce workload of color matching and the like, as compared to when the plate-printed image formation area is larger than the inkjet-printed image formation area.

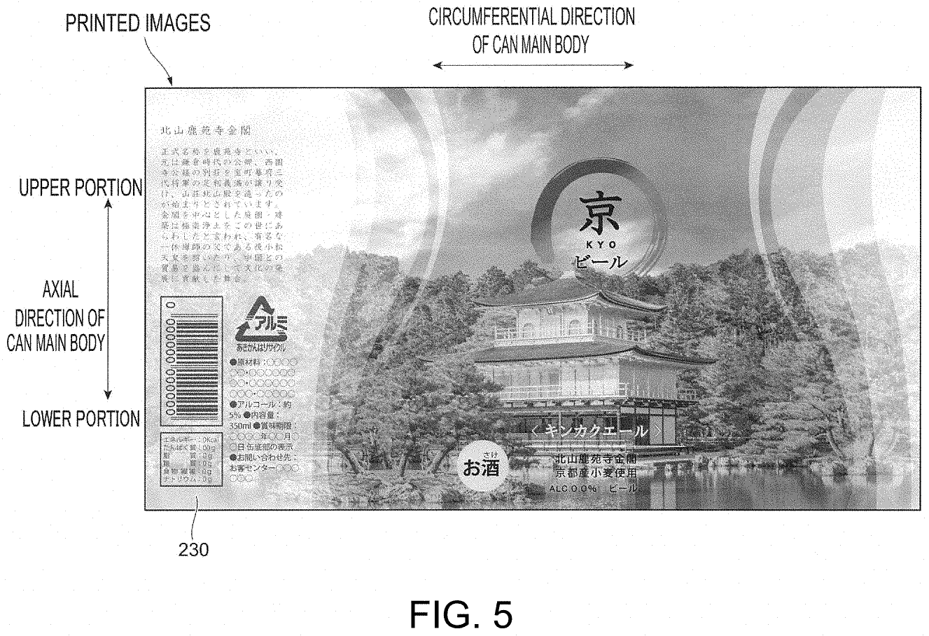

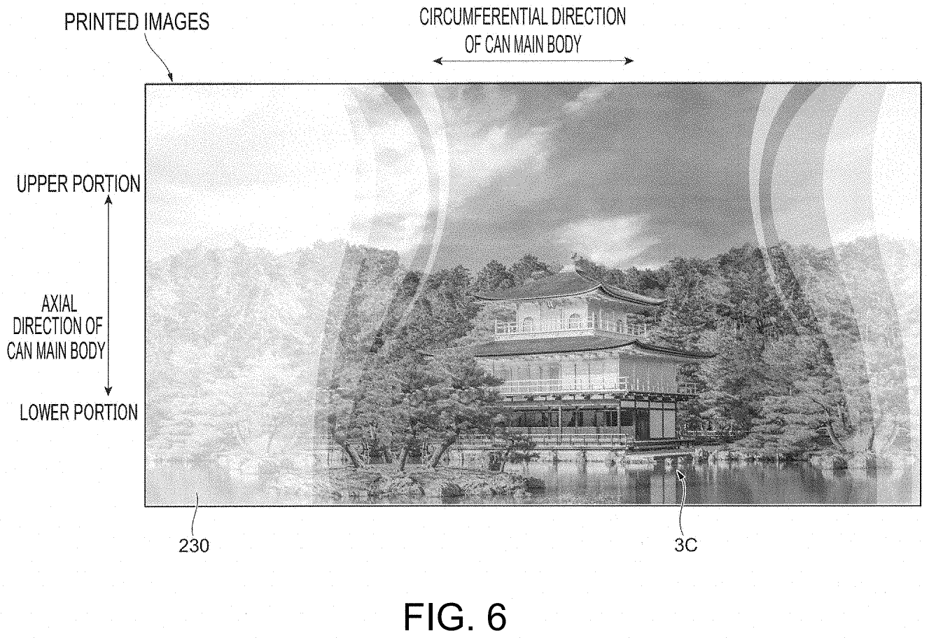

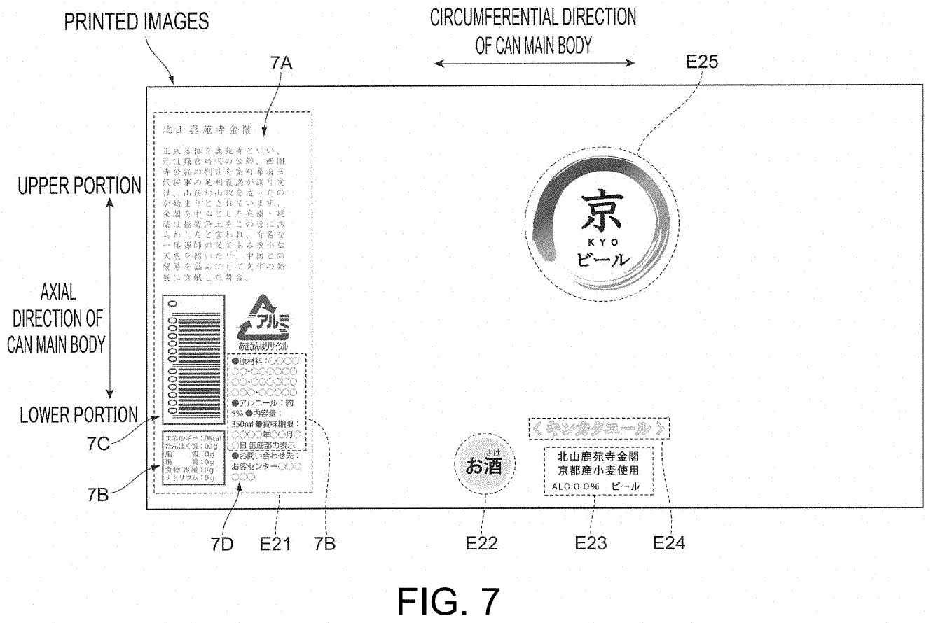

FIG. 5 is a developed view of other exemplary printed images formed on the outer circumferential surface 230 of the beverage use can 100. FIG. 6 shows printed images formed by inkjet printing among the printed images shown in FIG. 5. FIG. 7 shows printed images formed by plate printing among the printed images shown in FIG. 5.

The printed images shown in FIG. 5 are composed of a superposition of those shown in FIG. 6 and those shown in FIG. 7.

As shown in FIG. 6, in this example too, the inkjet-printed images are formed almost over the entirety of the outer circumferential surface 230 of the can main body 200.

The inkjet-printed images include a photo image 3C similarly to the above example. More specifically, the inkjet-printed images include a photo image 3C representing a temple.

As shown in FIG. 7, in this example too, plate-printed images are formed on the outer circumferential surface 230 of the can main body 200. More specifically, in this example, the plate-printed images are formed in five formation areas of first to fifth formation areas E21-E25.

The first formation area E21 has a rectangular shape extending in the axial direction of the can main body 200. As denoted by 7A, a character image representing a text for explaining the image (the image of the temple) included in the inkjet-printed images is formed in the first formation area E21. Similarly to the above example, a character image as denoted by 7B representing information on the contents in the can main body 200 is formed in the first formation area E21. Also, a code image as denoted by 7C and a character image representing a manufacturer as denoted by 7D are formed in the first formation area E21.

As shown in FIG. 7, a character image “alcohol” representing the kind of contents in the can main body 200 is formed in the second formation area E22. A character image representing the contents in the can main body 200 is formed in the third formation area E23.

A trademark is formed in the fourth formation area E24. Another trademark is formed in the fifth formation area E25.

Now a description will be given of a printing apparatus 400 for forming the inkjet-printed images and the plate-printed images.

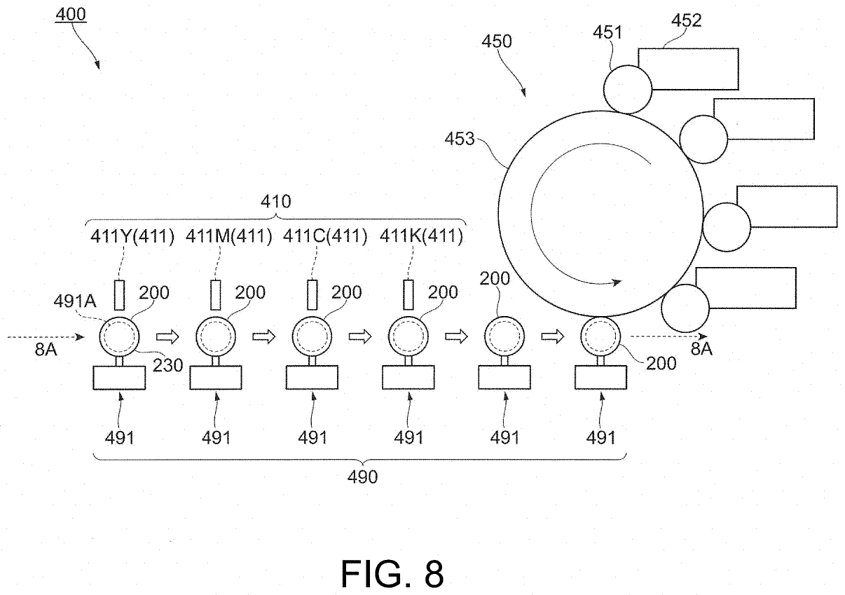

FIG. 8 is a side view of the printing apparatus 400.

The printing apparatus 400 includes an inkjet printing part 410 that forms images by inkjet printing (inkjet printing process) and a plate printing part 450 that forms images by plate printing (plate printing process). The printing apparatus 400 further includes a can conveying mechanism 490 that conveys the can main bodies 200 in the direction of an arrow 8A in the figure.

The plate printing part 450 is located downstream of the inkjet printing part 410 in the conveying direction of the can main bodies 200; in the present embodiment, plate printing is performed after inkjet printing.

The inkjet printing part 410 includes four inkjet heads 411. Specifically, the inkjet printing part 410 includes a first inkjet head 411Y ejecting yellow ink, a second inkjet head 411M ejecting magenta ink, a third inkjet head 411C ejecting cyan ink, and a fourth inkjet head 411K ejecting black ink.

The four inkjet heads 411 are positioned so as to extend in a direction perpendicular to the conveying direction of the can main bodies 200 (a direction perpendicular to the paper plane in the figure). Further, each of the four inkjet heads 411 is positioned so as to extend along the axial direction of the conveyed can main bodies 200.

Each of the four inkjet heads 411 is positioned above the conveying route of the can main body 200 and ejects ink onto the can main body 200 located below.

The can conveying mechanism 490 includes multiple moving units 491. Each moving unit 491 includes a mandrel 491A for supporting the can main body 200. The mandrel 491A is formed in a cylindrical shape and inserted into the can main body 200. Each moving unit 491 includes a motor (not shown) for rotating the mandrel 491A.

The can conveying mechanism 490 further includes a moving mechanism (not shown) for moving the moving units 491.

The moving mechanism may be a linear moving mechanism, for example. When a linear moving mechanism is used, an electromagnet is placed along a moving route of each moving unit 491 and a magnet is placed on each moving unit 491. Controlling the energization of the electromagnet allows each moving unit 491 to be moved.

Besides the linear moving unit, the moving mechanism may be any other known moving mechanism. Alternatively, each moving unit 491 may be mounted with a driving source such as a motor so as to move by itself.

The plate printing part 450 includes multiple plate cylinders 451. Each plate cylinder 451 includes, on its surface, projections (not shown) corresponding to the plate-printed images. The plate printing part 450 further includes multiple ink supply units 452 for supplying ink onto the projections of each plate cylinder 451.

The plate printing part 450 further includes a blanket 453 to which the ink is transferred from the plate cylinders 451 and that transfers the ink to each can main body 200.

The printing apparatus 400 sequentially conveys each can main body 200 to the downstream side using the can conveying mechanism 490. The can main body 200 is stopped below each of the four inkjet heads 411 and rotated in the circumferential direction.

In this state, ink is ejected from each inkjet head 411 onto the can main body 200 located below. Thus, in the present embodiment, color inkjet-printed images are formed on the outer circumferential surface 230 of the can main body 200 as it passes below the four inkjet heads 411.

In the present embodiment, the can main body 200 then moves to the print printing part 450, at which the can main body 200 is temporarily stopped. Further, the can main body 200 is rotated.

At the print printing part 450, ink is supplied from the ink supply units 452 onto the surfaces of the corresponding plate cylinders 451. The ink applied on the surface of each plate cylinder 451 (the ink applied on the projections of each plate cylinder 451) is then transferred onto the blanket 453. The ink transferred onto the blanket 453 is in turn transferred onto the can main body 200 being rotated. This forms the plate-printed images on the outer circumferential surface 230 of the can main body 200.

When the plate-printed images have a single color, use is made of a single ink supply unit 452 and a single plate cylinder 451 corresponding to the single ink supply unit 452. When the plate-printed images have two or more colors, use is made of multiple ink supply units 452 and multiple plate cylinders 451.

In the present embodiment, the plate-printed images of trademarks are formed in a single color and the other plate-printed images are formed in another single color; the plate-printed images are thus composed of two colors. Hence, in the present embodiment, use is made of two ink supply units 452 and two plate cylinders 451.

The present embodiment has described the case where the inkjet printing part 410 is located on the upstream side and the plate printing part 450 is located on the downstream side; when, however, the inkjet-printed images are to be formed after the plate-printed images, the positions of the printings parts are exchanged. That is, the plate printing part 450 is located on the upstream side and the inkjet printing part 410 is located on the downstream side.

Although not shown in the above figures, a white or other colored underlayer may be formed on the outer circumferential surface 230 of the can main body 200 when necessary prior to formation of the inkjet-printed images and the plate-printed images.

Although not shown in the figures, a curing process is performed downstream of the inkjet printing part 410 and the plate printing part 450, whereby the can main body 200 is heated or UV-irradiated to cure the inkjet-printed images and the plate-printed images thereon.

Although not shown in the figures, a protective layer forming process is also performed downstream of the inkjet printing part 410 and the plate printing part 450, whereby a paint is applied on the inkjet-printed images and the plate-printed images to form a protective layer thereon.

While in the above description the two printing parts of the inkjet printing part 410 and the plate printing part 450 are provided in the single printing apparatus 400, there may be installed two printing apparatuses 400 one of which performs inkjet printing and the other of which performs plate printing.

While in the above description the can main bodies 200 are linearly moved and conveyed in the printing apparatus 400 of the present embodiment, the can main bodies 200 may be moved along an annular route and the inkjet-printed images and the plate-printed images may be formed on the can main bodies 200 during their movement along the annular route.

### REFERENCE SIGNS LIST

3C Photo image
100 Beverage use can
200 Can main body (can body)
230 Outer circumferential surface
410 Inkjet printing part (inkjet printing process)
450 Plate printing part (plate printing process)

1. A method for manufacturing a beverage use can, the method comprising:
forming an image on an outer circumferential surface of a can body by inkjet printing; and
forming another image including a character image on the outer circumferential surface of the can body by plate printing, the another image being formed in an area that is smaller than another area in which the image is formed by inkjet printing.

2. The method for manufacturing a beverage use can according to claim 1, wherein
the image formed by the inkjet printing is formed over an entirety of the outer circumferential surface of the can body, and
the another image including the character image formed by the plate printing is formed on a portion of the outer circumferential surface of the can body.

3. The method for manufacturing a beverage use can according to claim 1, wherein image formation by the inkjet printing and image formation by the plate printing are performed such that the image formed by the inkjet printing and the another image formed by the plate printing do not overlap each other.

4. The method for manufacturing a beverage use can according to claim 1, wherein image formation by the plate printing is performed after image formation by the inkjet printing.

5. The method for manufacturing a beverage use can according to claim 1, wherein the inkjet printing comprises forming, on the outer circumferential surface of the can body, the image including a photo image.

6. The method for manufacturing a beverage use can according to claim 1, wherein the plate printing comprises forming, on the outer circumferential surface of the can body, the another image including the character image that represents at least one of information on a manufacturer and information on contents in the can body.

7. A method for manufacturing a beverage use can, the method comprising:
forming an image on an outer circumferential surface of a can body by inkjet printing; and
forming another image including a trademark and/or a code image on the outer circumferential surface of the can body by plate printing, the another image being formed in an area that is smaller than another area in which the image is formed by inkjet printing.

8. A method for manufacturing a beverage use can, the method comprising:
forming an image on an outer circumferential surface of a can body by inkjet printing; and
forming another image in an area on the outer circumferential surface of the can body by plate printing, the area extending in an axial direction of the can body, the area being smaller than another area in which the image is formed by inkjet printing.

9. The method for manufacturing a beverage use can according to claim 8, wherein
the area extending in the axial direction comprises a plurality of the areas extending in the axial direction, the plurality of the areas being located at mutually different positions in a circumferential direction of the can body, and
a sum of the plurality of the areas extending in the axial direction is smaller than the another area in which the image is formed by inkjet printing.

10. The method for manufacturing a beverage use can according to claim 8, wherein image formation by the plate printing is performed after image formation by the inkjet printing.

11. The method for manufacturing a beverage use can according to claim 8, wherein the image formed by the inkjet printing is formed over an entirety of the outer circumferential surface of the can body, and then the another image formed by the plate printing is formed on the image formed by the inkjet printing.

12. A method for manufacturing a beverage use can, the method comprising:
forming a multi-level image on an outer circumferential surface of a can body by inkjet printing, the multi-level image being included in images to be formed on the outer circumferential surface; and
forming a binary image by plate printing in an area that is smaller than another area in which the multi-level image is formed by inkjet printing.

13. A beverage use can comprising:
a can main body of a cylindrical shape;
an image part formed on an outer circumferential surface of the can main body, the image part being formed by inkjet printing;
another image part formed on the outer circumferential surface of the can main body, the another image part being smaller in area than the image part, the another image part being formed by plate printing, the another image part including at least one of a character image, a trademark, and a code image.

14. A beverage use can comprising:
a can main body of a cylindrical shape;
an overall image formed on an outer circumferential surface of the can main body such that the overall image extends in a circumferential direction of the can main body, the overall image being formed by inkjet head printing; and
a partial image formed on a portion of the outer circumferential surface of the can main body, the partial image including at least one of a character image, a trademark, and a code image, the partial image being formed by plate printing.

15. A beverage can comprising:
the beverage use can according to claim 13; and
contents in the beverage use can.
